(19) United States
(12) Patent Application Publication
(10) Pub. No.: US 2005/0071606 A1
(43) Pub. Date: Mar. 31, 2005

(54) Device, system and method of allocating spill cells in binary instrumentation using one free register

(76) Inventors: Roman Talyansky, Haifa (IL); Vladimir Vladimirov, Kiryat Ata (IL); Dmitry Kaptsenel, Nesher (IL); Ady Tal, Yaakov (IL); Amit Dagan, Shimshit (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/673,261

(22) Filed: Sep. 30, 2003

(51) Int. Cl. G06F 7/38; G06F 9/44

(52) U.S. Cl. 712/227; 717/130

(57) ABSTRACT

There are presented a method, device and system for allocating spill cells for an instrumentation fragment that is run on a processor that uses a register stack architecture where only one free register is available for such fragment.

### BACKGROUND OF THE INVENTION

In binary instrumentation pieces of binary code called instrumentation fragments may be added to a compiled and linked program at various points in the program. These binary fragments may for example collect information relating to the execution of the compiled program. For example, in the case of a coverage tool, instrumentation fragments may be added at various basic blocks to count the number of times each basic block is reached. Some instrumentation fragments rely on registers to temporarily store information generated by the fragment or by the binary image as it runs. In some tools, a register may be assigned to each instrumentation fragment that is inserted into a compiled binary code. In processors relying on architectures that use a register stack, it may be necessary to spill the data in a busy register before a thread processes an instrumentation fragment. Data that was in a busy register may be restored once the instrumentation fragment or a thread is completed. To facilitate a spill of busy registers, it may be necessary to identify free registers that may be linked with or available to an instrumentation fragment. Currently at least two free registers are required to facilitate such spilling in an instrumentation in some processors using a register stack. This requirement limits the instances where binary fragmentation may be used to those where two free registers are available.

### BRIEF DESCRIPTION OF THE DRAWINGS

Embodiments of the invention will be understood and appreciated more fully from the following detailed description taken in conjunction with the drawings in which:

FIG. 1A is a schematic diagram of components of a computer in accordance with an exemplary embodiment of the invention;

FIG. 1B is a schematic diagram of components of a central processing unit in accordance with an exemplary embodiment of the invention;

FIG. 2 is a schematic depiction of a lock array, a spill array and an index storage space in accordance with an exemplary embodiment of the invention;

FIG. 3 is a flow chart depicting certain operations for allocating a spill cell of a spill array in accordance with an exemplary embodiment of the invention;

FIG. 4 is a schematic depiction of a lock cell and a spill cell in accordance with an exemplary embodiment of the invention; and

FIG. 5 is a flow chart depicting certain operations for allocating a spill cell in accordance with an exemplary embodiment of the invention.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention.

Unless specifically stated otherwise, as apparent from the following discussions, it is appreciated that throughout the specification, discussions utilizing terms such as “processing,” “computing,” “calculating,” “determining,” “altering” or the like, refer to the actions and/or processes of a processor, computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The processes and displays presented herein are not inherently related to any particular computer, communication device or other apparatus. The desired structure for a variety of these systems will appear from the description below. In addition, embodiments of the present invention are not described with reference to any particular programming language, machine code, etc. It will be appreciated that a variety of programming languages, machine codes, etc. may be used to implement the teachings of the invention as described herein.

As used in this application the following terms may have the following meanings: ‘Threadsafe’ may mean for example measures or processes taken that ensure that different threads of a program do not interfere with each other. In some cases a threadsafe process may for example perform a read, increment and write-to-memory operation atomically so that a second process does not for example read the memory location between the point at which the first process reads the memory location and the point at which the first process writes the incremented value back to the memory location. Other operations or series of operations may be used to ensure that a process or instruction is threadsafe. ‘Fetchadd’ or ‘Fetch and add’ may mean or include a process that may perform increment, decrement or addition of a signed constant using an atomic read, increment and write to memory, such that the increment, decrement or constant addition is performed in a threadsafe manner. Other fetchadds may for example use semaphores or locks to ensure that an increment is performed in a threadsafe manner. Some fetchadd instructions, may for example retrieve, increment and store a value in a designated memory location for such value, and into a register or cache of a processor in an atomic fashion. Some fetchadd intructions may be performed when only a single free register is available to a processor. A ‘free register’ may mean a register that is not in use at a particular place in a program, or that holds a value that is not used or later called on in a program or instrumentation. A register that is not free may be said to be busy.

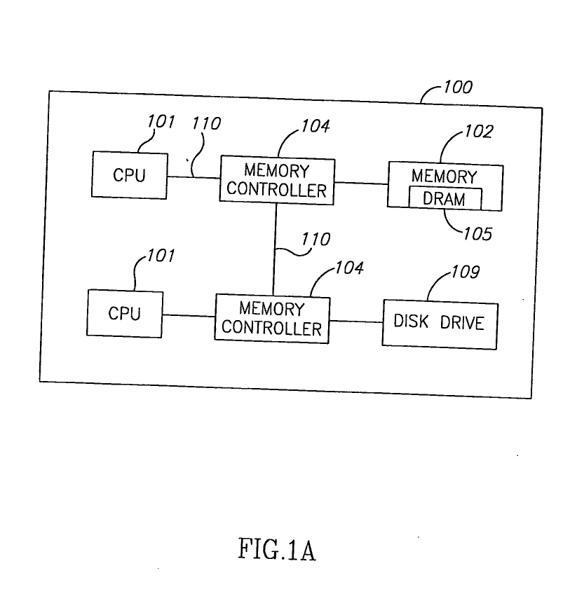

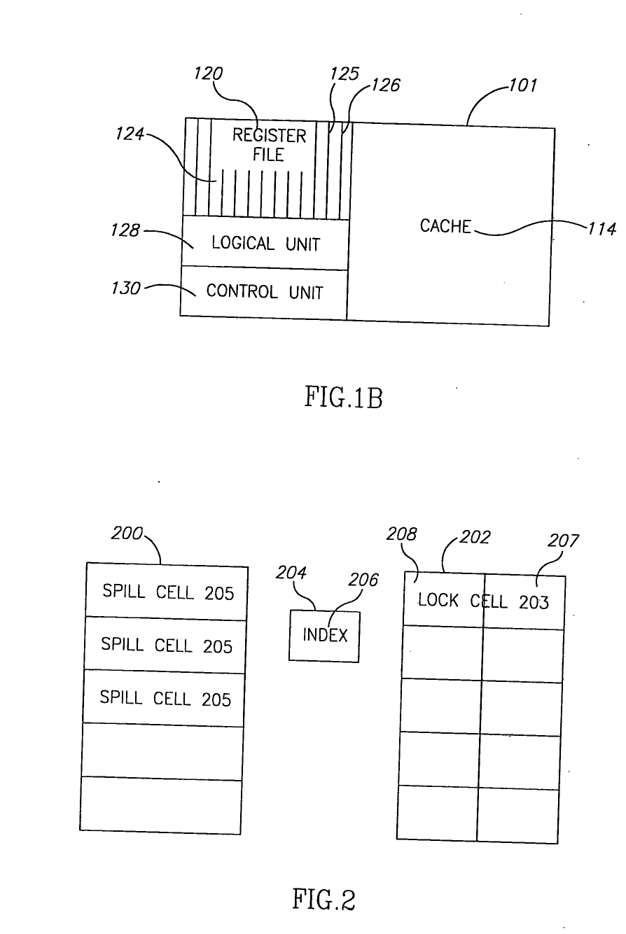

Reference is made to FIG. 1A, a block diagram of components of a computer with a processor and a memory in accordance with an exemplary embodiment of the invention. Computer 100 may include one or more central processing units (CPU) 101 which may be connected to one or more memory controllers 104. A bus 110 may connect CPUs 101 with one or more memory controllers 104 or with other components of computer 100. In some embodiments of the invention, CPU 101 may be a processor, which relies on a register stack architecture. Computer 100 may contain one or more data storage or memory 102 units. In some embodiments, memory 102 may be or include a dynamic random access memory storage unit 105. Memory controller 104 may be connected to other storage devices such as for example a disc drive 109.

Reference is made to FIG. 1B, a block diagram of components of a CPU 101 as described in FIG. 1A. CPUs 101 may include a register file 120 that may be or include registers 124 that may in some embodiments be disposed on or proximate to a CPU 101. Some of registers 124 may for purposes of a particular execution of a program code or instrumentation fragment be busy registers 125, while others may be free registers 126. CPU 101 may include logical units 128 that may in some embodiments perform logic instructions such as for example increments, decrements or other mathematical computations. CPU 101 may include one or more caches 114 that may temporarily hold values or data generated by CPU 101 or by other components or operations, or may hold for example instructions that may be waiting to be executed by CPU 101. CPU 101 may include a control unit 130 that in some embodiments may for example control the flow of values or data to and from cache 114 or for example between registers 124.

Reference is made to FIG. 2, a schematic depiction of a lock array, a spill array and an index variable space in accordance with an exemplary embodiment of the invention. In an embodiment of the invention there may be designated various data structures in an instrumentation or an instrumentation fragment that may be inserted into a binary image of a compiled program. In some embodiments such data structures may be designated, respectively as a spill array 200, a lock array 202 and an index variable element 204. Other designations may be used and such structures may be combined into one or more data structures or divided into a greater number of data structures.

In some embodiments, spill array 200 may be designated in memory 102 or in another data storage unit accessible to CPU 101. Spill array 200 may be or include one or more data storage areas or cells of memory wherein can be inserted or spilled data, such as for example data collected in a register 124 during an execution of an instrumentation fragment. In some embodiments data in busy registers 125 may be spilled into a spill cell 205 before an instrumentation fragment is run. In other embodiments, spill cells 205 may be used to store data collected from sources other than registers 124 such as memory 102, or from processes other than the execution of an instrumentation fragment. For example, a spill cell 205 may be used to temporarily store data generated during the execution of a thread. In some embodiments spill array 200 may be configured in forms other than an array, such as for example, a tree, a table, a hash table or other data structures.

In some embodiments, one or more spill cells 205 of spill array 200 may be indexed, by way of, for example, ascending numbers, such that each spill cell 205 of spill array 200 may be indexed by a unique number. In some embodiments index 206 may begin at zero and ascend to the number of spill cells 205 in spill array 200 minus 1. The number of spill cells 205 in spill array 200 may be designated to match the number of threads or expected number of threads, or expected maximum number of threads, that may be encountered in an execution of a binary code. In some embodiments, the number of spill cells 205 may be unrelated to the number of threads of a program. In order to avoid having all cells of a spill array 200 allocated at once, in some embodiments the number of spill cells 205 in a spill array 200 may exceed the number of threads that may be executed concurrently during an instrumentation fragment. In the event that all cells are allocated at once, a new thread that attempts to allocate a spill cell 205 may wait in a busy loop until one of the threads releases a spill cell 205.

In some embodiments, the number of spill cells 205 in a spill array 200 is equal to the number of cells in a lock array 202. In some embodiments, the number of cells in a lock array 202 and spill array 200 may be fixed when an instrumentation process is initiated.

The size or amount of memory designated for a spill cell 205 may in some embodiments depend on the type of software tool that is constructed by an instrumentation process. For example a coverage tool may impact a different number of registers than a thread checking tool, and the size of the spill cells 205 may be altered to accommodate such greater or smaller number of registers 124 to be spilled. Other factors may also impact the amount of memory that may be designated for each spill cell 205.

In some embodiments, lock array 202 may be designated in memory 102 or in another data storage cell connected with CPU 101. In some embodiments, lock array 202 may be configured in forms other than an array such as for example, a tree, a table, a hash table or other data structures. Lock cells 203 of lock array 202 may be indexed by index 206, such that the index 206 number of a first spill cell-205 of spill array 200 has the same index 206 number as the first lock cell 203 of lock array 202. The index 206 numbers of the second, third and further cells are likewise the same for lock cells 203 or spill cells 205. In some embodiments, an address in a memory, such as for example memory 102, of a first lock cell 203 of a lock array 202 may be inserted into an instrumentation fragment when the lock array 202 is designated in a memory such as for example memory 102.

In some embodiments, lock cells 203 of lock array 202 may be divided into two or more fields to store two or more values. The first value, which in some embodiments may be stored in the more significant positions 208 of lock cell 203, may be or include the index 206 number of the lock cell 203, which may for example correspond to the position of lock cell 203 in the lock array 202. The second value, which may in some embodiments be stored in the less significant positions 207 of lock cell 203, may store integers or other values which may be designated as lock cell values. Other designations, data formats or organization structures may be used.

Index variable element 204 may in some embodiments be a designated space in memory 102 or other memory location which may in some embodiments store index 206. The address of index variable element 204 may be moved into a free register 126 as is described in FIG. 1B using for example a move long immediate (movl) instruction or other suitable instructions as may store an address in a register 124. In some embodiments, similar instructions may be employed when further access is made to index variable element 204. In some embodiments, index 206 may be assigned an initial value of zero during an instrumentation process or at the beginning of a program. Index 206 may be incremented as access is made to further cells in lock array 202 or spill array 200. Other values for index 206 may be used.

In one embodiment of the invention, a spill cell 205 may be allocated for spilling the contents of busy registers 125 even though there is only a single free register 126 available for use during the execution of an instrumentation fragment or a thread.

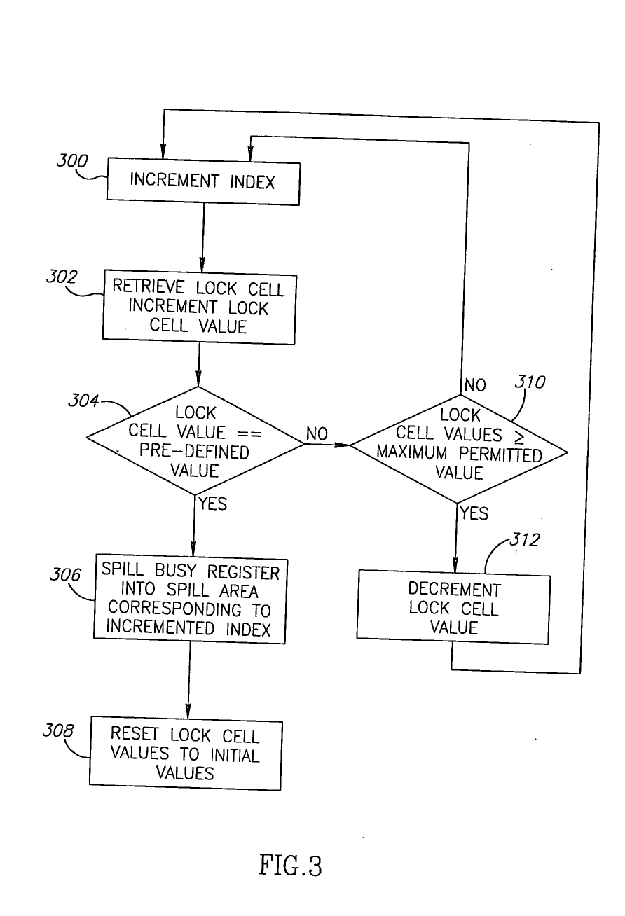

Reference is made to FIG. 3, a flow chart depicting certain operations in accordance with an exemplary embodiment of the invention. In some embodiments, a free register 126 may be found or designated as part of the preparation of the execution of a binary instrumentation fragment or thread. In some embodiments of the invention, an address of index variable element 204 may be read into a free register 126 using for example a movl instruction or other suitable instruction. In block 300, index 206 may be incremented, using, for example a fetchadd instruction or some other threadsafe process, and the incremented index 206 may be stored both in index variable element 204 and in free register 126. As described below, a series of instructions may calculate the address of the lock cell 203 that corresponds to the incremented index 206, using a single free register 126. In other embodiments, other methods may be used for calculating an address of a lock cell 203 in a lock array 202.

In block 302, a further fetchadd, or some other threadsafe instruction, may retrieve both the index 206 value as is stored in the most significant positions 208 of lock cell 203, and the lock cell value as is stored in the least significant positions 207 of lock cell 203. As a result, the incremented lock cell value is stored both in free register 126 and in lock cell 203. In one embodiment, the incrementing of lock cell value may effect only the least significant positions 207 of the retrieved lock cell 203 such that while the lock cell value is incremented, the index value of such lock cell 203 remains unchanged.

In block 304, a comparison is made of the incremented lock cell value of the lock cell 203 as it was read into free register 126, and a pre-defined value, such as for example 1. If the incremented lock cell value equals the pre-defined value, the method may continue in block 306. If the incremented value does not equal a pre-defined value, the method may continue in block 310.

If the incremented lock cell value equals a pre-defined value, it indicates that the lock cell 203 corresponding to the incremented index 206 was available and has now been successfully allocated for use by, for example, the current thread, and has not yet been taken by a previous thread, fragment or other use. For example, if a lock cell value is 1 (indicating that it was zero before it was incremented by for example a fetchadd as may have been used in the process of block 300), it indicates that the lock cell 203 was available and has now been allocated by the current instruction. Because lock array 202 and spill array 200 share index 206, a successful allocation of a lock cell 203 may indicate that the spill cell 205 with the same index 206 as the lock cell 203 may be available, and may been allocated to accept data to be spilled from busy registers 125.

At the end of the execution of an instrumentation fragment by a thread or at other intervals, the data that had been spilled into spill cell 205 may replaced back into the busy registers 125 from which such data may have been spilled.

In block 308, a threadsafe instruction, such as for example an ordered store instruction or a fetchadd instruction, may decrement or otherwise reset lock cell value to an initial value such as for example zero. The reset or re-initialized lock cell value may indicate that the lock cell 203 and its corresponding spill cell 205 may be available again for allocation.

In some embodiments, a predicate register or other suitable storage device or method may be used to compare an incremented lock cell value to a pre-defined value as was described in block 304 above. Because in one example it may be assumed that all predicate registers are busy, a predicate register may be freed prior to, or as part of, the process of performing such comparison. In some embodiments freeing a busy predicate register may entail reading and storing a single bit that may have been held in the predicate register, and restoring the bit once the desired comparison has been completed. Other numbers of bits may be used. In some embodiments, a bit from a predicate register may be held in a bit position that is left unallocated in for example, the index 206 field of a lock cell 203. In some embodiments, such unallocated bit position may be the most significant position in lock cell 203. As lock cell 203 is read into free register 126, free register 126 may likewise have a bit position that is unallocated or unused by either the index 206 field or the lock cell value field. In some embodiments, prior to the execution of a comparison, an instruction such as for example a shift right pair (SRP) instruction may move all of the allocated bits in free register 126 one position to the left such that the unallocated bit position in such free register 126 is moved to the least significant position. Freeing the least significant position in free register 126 may in some embodiments permit an instruction such as for example a conditional add instruction to read and store the value in a predicate register into, and subsequently out of, the least significant position in free register 126. Other suitable methods of achieving such read and store or such freeing a busy predicate register may be used.

In block 306, a spill of busy registers 125 may be-performed into allocated spill cell 205 that corresponds to the incremented index 206. In some embodiments, the pre-defined value to which a lock cell value may be compared may be set to 1, and the lock cell value may be initially set to 0. By doing so, the fetchadd increments the lock cell value from 0 to 1, and the allocation of the lock cell 203 as is determined by the comparison of the lock cell value to the pre-defined value may be deemed successful since the lock cell value matches the pre-defined value which may be 1. If the fetchadd instruction increments the lock cell value to greater than a pre-defined value such as 1, the allocation may be considered to be unsuccessful, indicating that the lock cell 203 and the corresponding spill cell 205 have already been allocated to a prior thread or to a prior instrumentation fragment. In some embodiments the predetermined value may be set to sums other than 1. In some embodiments, the pre-defined value may be stored in an instrumentation fragment. Other systems of notation and meaning may be used, and thus the specific values discussed herein may in other embodiments be different.

Returning to block 304, if the incremented lock cell value is not equal to the pre-defined value, the method proceeds to block 310. In block 310 a determination is made as to whether the lock cell value has been incremented so many times that it may overflow its allocated memory, and potentially compromise the index field of the lock cell 203, or otherwise interfere with the process described above. To determine whether there is such a risk, the process in block 310 compares the lock cell value to a maximum permitted value. If it is determined that the lock cell value is not overflowing the memory allocated to lock cell value, then the method proceeds to block 300. If it is determined that lock cell value is, or is close to, overflowing the memory allocated to the lock cell value, then the method proceeds to block 312.

A maximum permitted value may in some embodiments be set at for example 2ⁱ−Max#T (or at a value that is a function thereof), where i is the number of bits in lock cell 203 that may be used for storing a lock cell value, and MAX#T is the maximum number of threads that may run concurrently during the instrumentation fragment. Other quantities or methods of calculating maximum permitted values may be used. In block 312 a lock cell value may be reduced or decremented to a value that is above the pre-defined value to which lock cell value was compared in block 304.

In block 312, the lock cell value may be reduced or decremented to for example 2 or some other value that is greater than the pre-defined value to which lock cell value was compared in block 304, but less than the maximum permitted value. Other methods may be used to prevent a lock cell value from overflowing the memory allocated to it. For example, as a result of prior fetchadd instructions, a lock cell value may have been incremented several times. In some embodiments, an overflow check of the lock cell value may be made after it is incremented to determine if the lock cell value is greater than or equal to the maximum permitted value. In some embodiments, an overflow check as described above may be performed each time a lock cell value is incremented. In other embodiments, such a check may be performed periodically or at certain intervals in the course of the execution of an instrumentation fragment. In some embodiments, a lock cell value may be reduced, decremented or reset by a threadsafe instruction such as for example a fetchadd or ordered store instruction.

In some embodiments, a comparison of an incremented lock cell value to a maximum permitted value may be performed using a predicate register. In some embodiments such predicate register may be freed through a process similar to that described above in respect of block 304 in the comparison of a lock cell value to a pre-defined value.

To avoid incrementing index 206 beyond the number of cells in the lock array 202, in some embodiments an instruction may reduce index 206 modulo to the number of the cells in lock array 200, e.g., dividing the incremented index 206 by the number of cells in the lock array 202 and returning the remainder. Reducing index 206 by the number of cells in lock array 202, may in some embodiments wrap the incremented index 206 back into the cells of the lock array 202 where it would otherwise have exceeded the number of cells in the lock array 202. Such a wrap may facilitate finding lock cells 203 or spill cells 205 that have been freed and are again available for allocation. In some embodiments where the number of cells in a spill array 200 is chosen as a power of two, such as for example 2ⁱ, a reduction or modulo as described above may be accomplished by extracting the least significant bits of index 206. For example, if a length of a spill array 200 or lock array 202 is 2ⁱ, and an index 206 after an increment equals j, a wrap may be accomplished by extracting the i lower bits of j. Such an extraction may be performed each time index 206 is incremented or with other periodicity.

In some embodiments, exceptions may occur during the execution of an instruction. Some of such exceptions may be deferred rather than generating a fault. Where a register 124 is the target of the instruction which caused the exception, a designated bit that may be associated with such register 124 may be set to for example 1 to indicate the deferral of the exception. Such bit may be referred to as a NaT bit. A set NaT bit may in some embodiments be used for example later in a process to detect a deferred exception that may have occurred. In some embodiments a register 124, which may for example be referred to as a user NaT collection register (UNAT), may be designated to collect NaT bits of other registers 124 that have been spilled. In some embodiments of the present invention, when a register 124 that has an associated NaT bit, is spilled, the data of such spilled register may be passed through a floating point register to prevent the corruption of the content of the UNAT register.

In some embodiments, it may be necessary to calculate from index 206 the address of a lock cell 203 as such lock cell 203 may be stored in a memory such as for example memory 102. To calculate such address when only a single free register 126 is available, one or more instructions or series of instructions may be used. The result of such instructions may in some embodiments be the addition of the offset of index 206 corresponding to the j^{th} lock cell 203 to the address of the first lock cell 203 in the lock array 202. For example, as described in block 300 an incremented index 206 may be calculated into an offset, and read into free register 126, such that free register 126 stores a value equal to the offset of the index of j^{th} lock cell 203. Such offset value may initially occupy the least significant positions of free register 126. The address of the first lock cell 203 in the lock array 202, which may in some embodiments be a unique value, such as a 64 bit value, may be divided into for example three or more address parts of 21 or 22 bits each. Other sizes and number of parts may be used. The least significant, or first address part, of such three parts may be added to the offset value as is stored in the free register 126 by way of a threadsafe instruction such as for example an addl. A further instruction such as for example, a shift right pair instruction may cyclically move the sum of the offset value plus the first address part to the most significant positions of free register 126. A middle address part of such three address parts may then be added to free register 126 by way of for example a further addl instruction, and a further shift right pair instruction may cyclically move such middle address part over to the most significant positions of free register 126. The most significant, or third address part may be added to free register 126 by way of for example an addl, and a further shift right pair instruction may cyclically move such third address part to the most significant positions of free register 126. The result of such instructions may be that free register 126 stores the address of the j^{th} lock cell 203 which was derived by adding the address of the first lock cell 203 in lock array 202 to the offset of the index 206 of the j^{th} lock cell 203. Other methods of calculating the address of a j^{th} lock cell 203 from index 206 may also be used.

In some embodiments, it may be advisable to include in an instrumentation fragment a structure such as a self-modifying code that may modify each of the three address parts described above to compensate for differences, if any, between the preferred base address of an image, on the one hand, and the actual base address as is assigned by the loader, on the other hand. In some embodiments, such self-modifying code may run before the process described in the pervious paragraph. Other methods of modifying the addresses to compensate for differences between actual and preferred base addresses are possible.

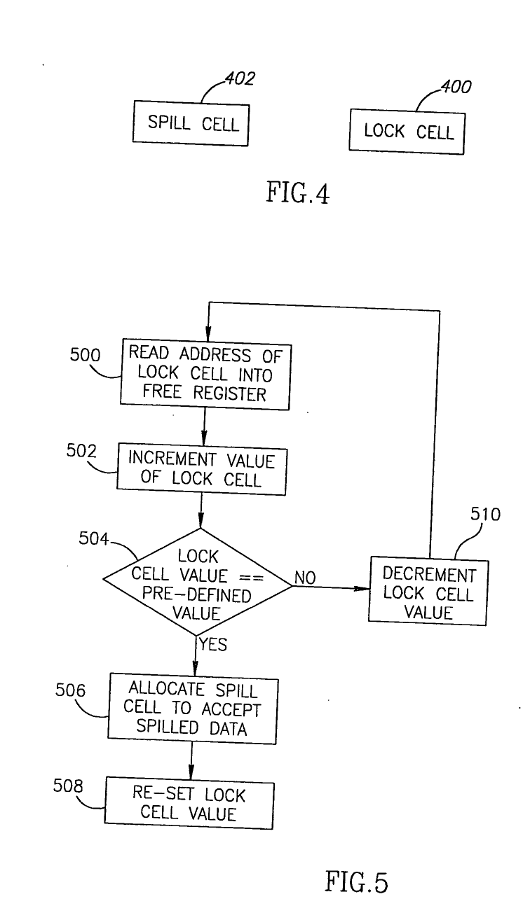

Reference is made to FIG. 4, a schematic depiction of a lock cell 400 and a spill cell 402 in accordance with an exemplary embodiment of the invention. In some embodiments there may be designated a lock cell 400 and a spill cell 402, each with a single cell rather than an array of cells. Structures other than cells may also be used. In some embodiments lock cell 400 may store a lock cell value. In some embodiments, spill cell 402 may be a data structure that may be included in a memory such as memory 102. Other sources of memory may be designated for spill cell 402. Spill cell 402 may be suitable for storing the contents of busy registers 125 which may be spilled into spill cell 402 before or as part of the execution of an instrumentation fragment. Other data structures or methods of allocating memory for spill cell 402 are possible.

Reference is made to FIG. 5, a flow chart depicting certain operations for allocating a spill cell in accordance with an exemplary embodiment of the invention. In block 500 the address of lock cell 400 may be read into a free register 126. In block 502, a threadsafe instruction such as for example a fetchadd instruction may move, increment and write a lock cell value of lock cell 400. Such incremented value may be stored both in a free register 126 and in lock cell 400.

In bock 504 a determination is made as to whether the incremented lock cell value equals a pre-defined value. If the incremented lock cell value equals a pre-defined value, the process moves to block 506. If the incremented lock cell value does not equal a pre-defined value, the method proceeds to block 510. If the incremented lock cell value equals a pre-defined value, it may indicate that the lock cell 400 and spill cell 402 have not been allocated to another thread or fragment and that spill cell 402 is available for spilling from busy registers 125.

In some embodiments, a lock cell value may be initialized to 0 and a pre-defined value may be 1. In other embodiments, other values may be used as an initial lock cell value and as a pre-defined value.

In block 506, a spill cell 402 may be allocated for spilling of busy registers 125 by the current thread or instrumentation fragment, and data may be spilled from busy registers.

In block 508, and in some embodiments at the end of instrumentation fragment, the data that had been spilled into spill cell 402 may be restored into the busy registers 125 from where it was spilled, and the lock cell values may be re-set to a pre-defined value such as for example 0. The reset lock cell value may indicate that the lock cell and its corresponding spill cell 402 are available again for allocation. Other operations or series of operations may be used.

Returning to block 504, if an incremented lock cell value is not equal to a pre-defined value the process continues to block 510. An incremented lock cell value that is not equal to a pre-defined value may indicate that lock cell 400 and spill ceil 402 have already been allocated for another use or another thread. The instrumentation may then have to wait until lock cell 400 and spill cell 402 becomes available for allocation.

In block 510 a threadsafe instruction such as for example a fetchadd may decrement or otherwise reduce a lock cell value to a sum that is equal to or above a pre-defined value, and the process may begin again at block 500.

At the end of the execution of a thread or an instrumentation fragment or at other intervals, the data that had been spilled into spill cell 402 may be replaced back into the busy register 125 from which such data was spilled.

The embodiment of the invention that includes a single lock cell 400 and a single spill cell 402 may be used with instrumentation points where the number of threads running concurrently does not result in undue busy/waiting conditions when the single spill cell 402 is allocated to other threads or fragments.

It will be appreciated by persons skilled in the art that embodiments of the invention are not limited by what has been particularly shown and described hereinabove. Rather the scope of at least one embodiment of the invention is defined by the claims below.

1. A method comprising allocating spill cells used by an instrumentation fragment that has access to a single free register and that is run on a processor with a register stack architecture.

2. A method as in claim 1, where said allocating comprises:
designating an index for a spill array and a lock array;
incrementing said index;
loading said incremented index in said free register;
altering a value in a cell of said lock array;
determining whether said altered value in said cell of said lock array equals a pre-defined value; and
allocating said spill cell corresponding to said incremented index.

3. A method as in claim 2, further comprising reducing said incremented index by the number of cells in said lock array if said incremented index exceeds the number of cells in said lock array.

4. A method as in claim 2, wherein said incrementing said index comprises executing a threadsafe instruction.

5. A method as in claim 2, wherein said determining whether said altered value equals a pre-defined value comprises freeing a predicate register.

6. A method as in claim 2, wherein said altering said value in said lock array comprises incrementing said value.

7. A method as in claim 2, comprising reducing said altered value of said lock array if said altered value equals a maximum permitted value.

8. A method comprising:
storing an incremented index in a free register of a processor, such processor using a register stack architecture;
calculating in said free register the address of a cell of a first array corresponding to said incremented index;
loading in said free register an incremented value from said cell of said first array;
comparing said incremented value in said free register to a pre-defined value; and
allocating a cell of a second array corresponding to said index in said free register if said incremented value equals said predefined value.

9. A method as in claim 8, comprising reducing said incremented index modulo to the number of cells in said first array.

10. A method as in claim 8, comprising reducing said incremented value if said incremented value equals a maximum permitted value.

11. A method of spill cell allocation comprising:
storing an incremented value in a memory and in a free register of a processor that uses a register stack architecture;
comparing said incremented value in said free register to a pre-defined value;
allocating a spill cell if said incremented value in said free register equals said pre-defined value; and
re-setting said incremented value in said memory.

12. A method as in claim 11, comprising determining if said incremented value equals a maximum permitted value.

13. A method as in claim 11, comprising reducing said incremented value if said incremented value equals a maximum permitted value.

14. A device comprising a processor with a register stack architecture, said device capable of allocating a spill cell using one free register.

15. A device as in claim 14, said processor to:
store an incremented index of an array in said free register;
calculate in said free register the address of a cell of an array corresponding to said incremented index;
load in said free register an incremented value from said cell of said array;
compare said incremented value in said free register to a pre-defined value; and
allocate a spill cell of a spill array corresponding to said index in said free register if said incremented value equals said pre-defined value.

16. A device as in claim 15, said processor further to determine if said incremented value equals a maximum permitted value.

17. An article comprising a storage medium having stored thereon instructions that, when executed by a processor, result in: storing an incremented index of an array in a free register of a processor using a register stack architecture;
calculating in said free register the address of a cell of an array corresponding to said incremented index;
loading in said free register an incremented value from said cell of said array;
comparing said incremented value in said free register to a pre-defined value; and
allocating a spill cell of a spill array corresponding to said index in said free register if said incremented value equals said predefined value.

18. An article as in claim 17, wherein said instructions further result in determining if said incremented value equals a maximum permitted value.

19. An article as in claim 18, wherein said instructions further result in reducing said incremented value if said incremented value equals a maximum permitted value.

20. A system comprising:
a dynamic random access memory storage unit; and
a processor with a register stack architecture capable of allocating a spill cell using one free register.

21. A system as in claim 20, said processor to
store in said free register an incremented index of an array;
calculate in said free register the address of a cell of an array corresponding to said incremented index;
load in said free register an incremented value from said cell of said array;
compare said incremented value in said free register to a pre-defined value; and
allocate said spill cell of a spill array corresponding to said index in said free register if said incremented value equals said pre-defined value.

22. A system as in claim 20, said processor to determine if said incremented value equals a maximum permitted value.

23. A processor to:
store an incremented index in a free register of said processor, such processor using a register stack architecture;
calculate in said free register the address of a cell of a first array corresponding to said incremented index;
load in said free register an incremented value from said cell of said first array;
compare said incremented value in said free register to a pre-defined value; and
allocate a cell of a second array corresponding to said index in said free register if said incremented value equals said predefined value.

24. The processor of claim 23, the processor to reduce said incremented index modulo to the number of cells in said first array.

25. The processor of claim 23, the processor to reduce said incremented value if said incremented value equals a maximum permitted value.
